(19) United States
(12) Patent Application Publication
(10) Pub. No.: US 2008/0053597 A1
(43) Pub. Date: Mar. 6, 2008

(54) Multilayer hose

(75) Inventors: Richard Wayne Hatchett, Huntingdon, TN (US); John Mobley, Lexington, TN (US); Jerry Shifman, Wildersville, TN (US); Jeremy W. Duke, Lexington, TN (US)

Correspondence Address: DAYCO PRODUCTS, LLC, 1 PRESTIGE PLACE, MIAMISBURG, OH, 45342, US

(73) Assignee: Dayco Products, LLC

(21) Appl. No.: 11/711,699

(22) Filed: Feb. 27, 2007

Related U.S. Application Data
(63) Continuation-in-part of application No. 11/513,371, filed on Aug. 30, 2006.

(51) Int. Cl. F16L 11/04

(52) U.S. Cl. 156/149; 428/36.91

(57) ABSTRACT

A fuel filler and fuel vent hose having reduced fuel permeation, comprises an elastomeric inner layer, a fluoropolymer barrier layer formed from tetrafluoroethylene-hexafluoropropylene-vinylidene fluoride terpolymer; tetrafluoroethylene-hexafluoropropylene-vinylidene fluoride-perfluorovinyl ether quadpolymer; or blends of two or more tetrafluoroethylene-hexafluoropropylene-vinylidene fluoride copolymers or terpolymers on the elastomeric inner layer, and a chlorinated polyethylene backing layer. Optionally, the fuel filler and fuel vent hose include an adhesive layer between the fluoropolymer barrier layer, and the chlorinated polyethylene backing layer, and an optional reinforcement layer as well as an additional outer cover layer. A method of forming such tubular structures is also included.

This application is a continuation-in-part of U.S. patent application Ser. No. 11/513,371, filed Aug. 30, 2006.

### BACKGROUND OF THE INVENTION

The present invention relates to the field of multilayer hoses, and particularly to the field of flexible multiplayer polymeric hoses for use in fuel, chemical and vapor transport

Flexible polymeric hoses are generally used in a variety of uses such as automobile fuel feed hoses, fuel vent hoses, torque converter hoses, power steering hoses, air conditioner hoses, brake fluid hoses, industrial hydraulic hoses and compressed gas hoses, refrigerator hoses, garden hoses, propane gas hoses, etc. Various types of tubing construction have been employed to meet the needs of the various applications of hoses. For example, multilayer tubular structures are commonly used in the automotive industry as fuel and chemical transport hoses and fuel vent hoses. Choosing the right combination of materials used in the construction of such hoses is becoming more difficult due to environmental regulations that severely limit the amount of fuel vapor that can permeate from the fuel system of a motor vehicle. Typically, fuel filler and vent hoses are multilayer tubular structures constructed of a natural or synthetic rubber material such as a conductive nitrile, e.g., acrylonitrile rubber, a fluoropolymer barrier layer such as a tetrafluoroethylene-hexafluoropropylene-vinylidene fluoride terpolymer (THV) barrier layer, a nitrile backing layer, a reinforcement layer and a chlorinated polyethylene (CPE) cover layer.

The overall cost and effectiveness of such hoses has proven to be somewhat disappointing. Therefore, there is a need for a fuel and chemical transport hose as well as a fuel vent hose that is more economical to produce and which exhibits improved properties.

### SUMMARY OF THE INVENTION

According to the present invention there is provided an improved multilayer tubular structure which is less costly to manufacture than prior multilayer fuel transport hoses and, in some cases, like fuel-alcohol blends, the fuel resistance, heat resistance and ozone resistance of chlorinated polyethylene is superior to the nitrile currently used as a backing layer. In addition to reduced permeability, the hose has adequate strength and durability over long periods of time, and is resistant to chemical degradation by the fluids being transported therein.

The elastomeric inner layer of the tubular structure of the invention is a nitrile elastomer such as acrylonitrile elastomer, or other elastomeric material such as chlorinated polyethylene and the like. Preferably, the elstomeric inner layer is an acrylonitrile-butadiene rubber or chlorinated polyethylene (CPE).

Typically, fuel filler and vent hoses have been manufactured from multilayer tubular structures constructed of a natural or synthetic rubber material such as a conductive nitrile, e.g., acrylonitrile rubber, employing a nitrile backing layer. It has now been found that chlorinated polyethylene is more economical than nitrile elastomers as a backing layer, and the chlorinated polyethylene offers improved fuel resistance and heat resistance over nitrile elastomers.

In those instances where the tetrafluoroethylene-hexafluoropropylene-vinylidene fluoride (THV) is adjacent the chlorinated polyethylene layer, it is advantageous to use an adhesive, such as an amine adhesive to provide sufficient adhesion between the chlorinated polyethylene and the fluoropolymer barrier layer as set forth below.

Since it is well known in the industry that hoses used to transport fuels employ a conductive agent or otherwise exhibit conductive characteristics in order to dissipate any electrical buildup, which may occur during the flow of fuel through the hose, the inner layer of the hose of the present application preferably, contains therein such a conductive agent.

In a first manifestation, the multilayered tubular structure of the present invention comprises: an elastomeric nitrile inner layer, a fluoropolymer barrier layer, an adhesive layer, and a chlorinated polyethylene (CPE) cover layer.

In a second manifestation, the multilayered tubular structure of the present invention comprises: an elastomeric nitrile inner layer, a fluoropolymer barrier layer, a reinforcement member, and a chlorinated polyethylene cover layer.

In a third manifestation, the multilayered tubular structure of the present invention comprises an elastomeric nitrite inner layer, a fluoropolymer barrier layer, an adhesive layer, a chlorinated polyethylene backing layer, a reinforcement, and a cover layer.

In a fourth manifestation, the multilayered tubular structure of the present invention comprises a chlorinated polyethylene inner layer, an adhesive layer, a fluoropolymer barrier layer, and a cover layer.

In a fifth manifestation, the multilayered tubular structure of the present invention comprises a chlorinated polyethylene inner layer, a first adhesive layer, a fluoropolymer barrier layer, a second adhesive layer, and a chlorionated polyethylene cover layer.

In a sixth manifestation, the multilayered tubular structure of the present invention comprises a chlorinated polyethylene inner layer, an adhesive layer, a fluoropolymer barrier layer, a reinforcement member, and a cover layer.

In a seventh manifestation, the multilayered tubular structure of the present invention comprises a chlorinated polyethylene inner layer, a first adhesive layer, a fluoropolymer barrier layer, a second adhesive layer, and a chlorinated polyethylene cover layer.

In an eighth manifestation, the multilayered tubular structure of the present invention comprises a chlorinated polyethylene inner layer, a first adhesive layer, a fluoropolymer barrier layer a second adhesive layer, a chlorinated polyethylene backing layer, a reinforcement member, and a cover layer.

Typically, the hoses of present invention are useful as automobile fuel vent hoses, fuel filler hose, vapor lines and fuel feed lines.

### BRIEF DESCRIPTION OF THE DRAWINGS

FIG. 1 is a perspective cutaway view illustrating a first manifestation of a tubular member of the present invention;

FIG. 2 is a perspective cutaway view illustrating a second manifestation of a tubular member of the present invention;

FIG. 3 is a perspective cutaway view illustrating a third manifestation of a tubular member of the present invention;

FIG. 4 is a perspective cutaway view illustrating a fourth manifestation of a tubular member of the present invention;

FIG. 5 is a perspective cutaway view illustrating a fifth manifestation of a tubular member of the present invention;

FIG. 6 is a perspective cutaway view illustrating a sixth manifestation of a tubular member of the present invention;

FIG. 7 is a perspective cutaway view illustrating a seventh manifestation of a tubular member of the present invention; and

FIG. 8 is a perspective cutaway view illustrating an eighth manifestation of a tubular member of the present invention.

### DETAILED DESCRIPTION OF THE INVENTION

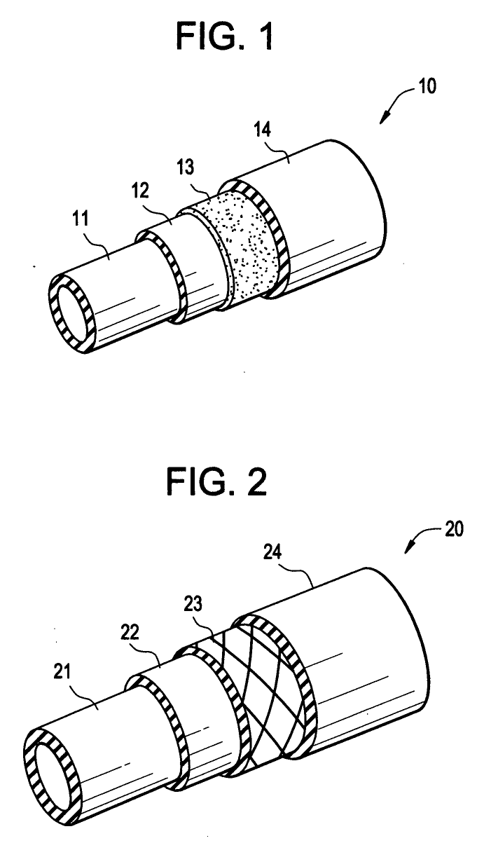

With respect to the drawings, FIG. 1 is a tubular structure in accordance with a first embodiment of the invention where an inner tubular structure 10 is made from a nitrile polymeric material 11, a fluoropolymer barrier layer 12 surrounding the outer surface of the nitrile layer 11, an adhesive layer 13 on the surface of the fluoropolymer barrier layer 12, and a chlorinated polyethylene cover 14 on top of the adhesive layer 13 and forming the outside layer of the tubular structure 10.

FIG. 2 is a tubular structure in accordance with a second embodiment of the invention where a tubular structure 20 is made from a nitrile material 21, a fluoropolymer barrier layer 22 surrounding the outer surface of the nitrile layer 21, a reinforcement layer 23 surrounding the fluoropolymer barrier layer 22, and a chlorinated polyethylene outer cover 24 surrounding the reinforcement layer and forming the outside layer of the tubular structure 20.

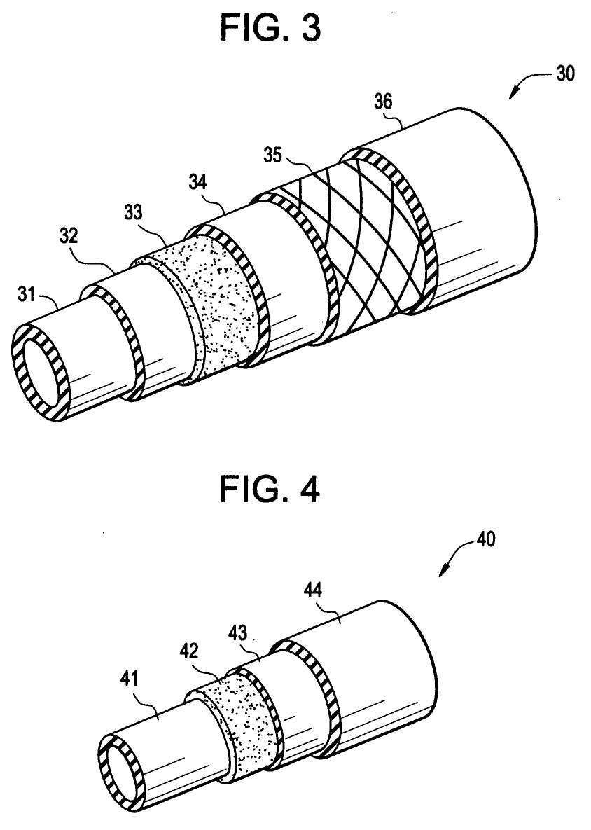

FIG. 3 is a tubular structure in accordance with a third embodiment of the invention where a tubular structure 30 is made from a conductive nitrile material 31, a fluoropolymer barrier layer 32 on the outer surface of the conductive nitrile material 31, an adhesive layer 33 on the outer surface of the fluoropolymer barrier layer 32, a chlorinated polyethylene backing layer 34 surrounding the outer surface of the adhesive layer 33, a reinforcement layer 35 surrounding the chlorinated polyethylene backing layer 34, and a chlorinated polyethylene outer cover layer 36 surrounding the reinforcement layer 35 and forming the outside layer of the tubular structure 30.

FIG. 4 is a tubular structure in accordance with a fourth embodiment of the invention where a tubular structure 40 is made from a conductive chlorinated polyethylene material 41, a adhesive layer 42 surrounding the conductive chlorinated polyethylene inner layer 41, a fluoropolymer barrier layer 43 surrounding the adhesive layer 42 adhesive layer 42, and a cover layer 44 surrounding the fluoropolymer barrier layer 43 and forming the outside layer of the tubular structure 40.

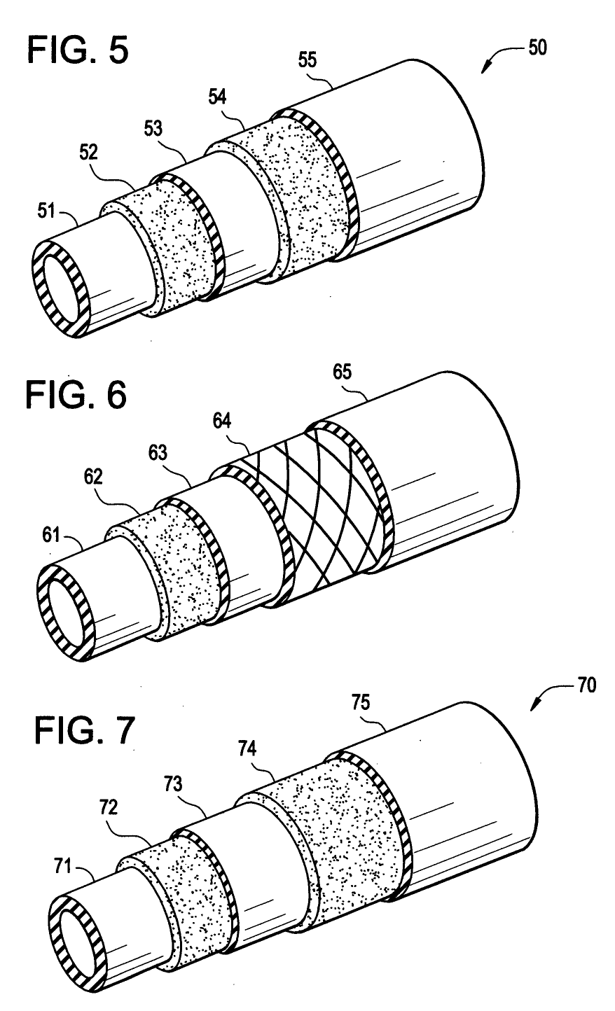

FIG. 5 is a tubular structure in accordance with a fifth manifestation of the invention where a tubular structure 50 is made from a conductive chlorinated polyethylene material 51, a first adhesive layer 52 surrounding the chlorinated polyethylene inner layer 51, a fluoropolymer barrier layer 53 surrounding the first adhesive layer 52, a second adhesive layer 54 surrounding the fluoropolymer barrier layer 53, and a chlorinated polyethylene cover layer 55 surrounding the second adhesive layer 54 and forming the outside layer of the tubular structure 50.

FIG. 6 is a tubular structure in accordance with a sixth manifestation of the invention where a tubular structure 60 is made from a conductive chlorinated polyethylene material 61, an adhesive layer 62 surrounding the chlorinated polyethylene inner layer 61, a fluoropolymer barrier layer 63 surrounding the adhesive layer 62, a reinforcement member 64 surrounding the fluoropolymer barrier layer 63, and a cover layer 65 surrounding the second adhesive layer 64 and forming the outside layer of the tubular structure 60.

FIG. 7 is a tubular structure in accordance with a seventh manifestation of the invention where a tubular structure 70 is made from a conductive chlorinated polyethylene material 71, a first adhesive layer 72 surrounding the chlorinated polyethylene inner layer 71, a fluoropolymer barrier layer 73 surrounding the first adhesive layer 72, a second adhesive layer 74 surrounding the fluoropolymer barrier layer 73, and a chlorinated polyethylene cover layer 75 surrounding the second adhesive layer 74 and forming the outside layer of the tubular structure 70.

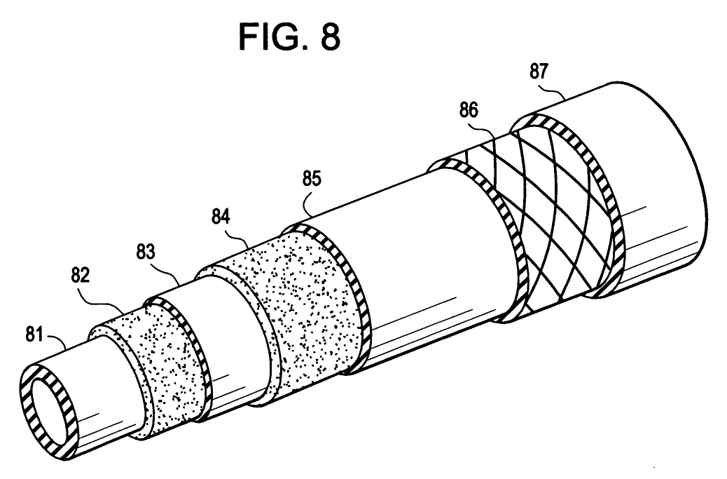

FIG. 8 is a tubular structure in accordance with a sixth manifestation of the invention where a tubular structure 80 is made from a conductive chlorinated polyethylene material 81, a first adhesive layer 82 surrounding the chlorinated polyethylene inner layer 81, a fluoropolymer barrier layer 83 surrounding the first adhesive layer 82, a second adhesive layer 84 surrounding fluoropolymer barrier layer 83, a chlorinated polyethylene backing layer 85 surrounding the second adhesive layer 84, a reinforcement member 86 surrounding the chlorinated polyethylene layer 85, and a cover layer 87 surrounding the reinforcing layer 86 and forming the outside layer of the tubular structure 80.

Typically, the inner layer of the tubular structure is an elastomeric or rubber material such as a nitrile or chlorinated polyolefin, e.g., chlorinated polyethylene. While other conventional elastomeric materials may be used if desired, the inner layer, preferably, is either an acrylonitrile-butadiene polymer or a chlorinated polyethylene. Where a chlorinated polyethylene is employed in the tubular structure of the present invention, an adhesive material may be advantageously applied between the chlorinated polyethylene layer and the fluoropolymer layer.

The barrier layer of the tubular structure is a fluoropolymer that prevents or reduces the permeation of fuel, chemical and vapor through the barrier layer. Typically, the barrier layer is a fluoropolymer containing polymerized units of tetrafluoroethylene, hexafluoropropylkene and vinylidene fluoride. Preferably, the fluoropolymer is a tetrafluoroethylene-hexafluoropropylene-vinylidene terpolymer (THV); a fluoroquad polymer derived from (i) tetrafluoroethylene (ii)hexafluoropropylene (iii) vinylidene fluoride and (iv) a perfluorovinyl ether; or a blend of about 20 to 80 weight percent of a first fluorointerpolymer having a fluorine content of about 65 to 73 weight percent with about 80 to 20 weight percent of a second fluorointerpolymer having a fluorine content of about 70 to 75 weight percent, wherein said first fluorointerpolymer is a copolymer or terpolymer formed by the copolymerization of two or more monomers selected from the group consisting of tetrafluoroethylene, hexafluoropropylene and vinylidene fluoride, and said second fluoropolymer is a terpolymer formed by the copolymerization of tetrafluoroethylene, hexafluoropropylene, and vinylidene fluoride, wherein said first fluorointerpolymer exhibits elastomeric characteristics and said second fluorointerpolymer exhibits thermoplastic characteristics. Such fluoropolymer blends are more fully described in U.S. Pat. No. 6,203,873, the contents of which is incorporated herein by reference thereto.

The reinforcement materials useful in the present invention are materials which afford physical strength to the finished hose. Typically, the reinforcement member is a plurality of synthetic or natural fibers selected from the group consisting of glass fibers, cotton fibers, polyamide fibers, polyester fibers, rayon fibers and the like. Preferably, the reinforcement material is an aromatic polyamide such as Kevlar or Nomex, both of which are manufactured by DuPont. The reinforcing materials may be knitted, braided or spiraled to form the reinforcement member. In a preferred aspect of the invention, the reinforcing material is spiraled. While the reinforcement member may be a preferred component of the present hose structure, it is not critical in every application. Therefore, the reinforcement member may or may not be used in the manufacture of certain hoses depending on the requirements of the manufacturer.

Typically, the inner layer of the tubular structure contains a conductive material such as metal or carbon. Preferably, the conductive material is carbon in the form of carbon black, but may be any conductive agent or combination of conducting agents commonly recognized in the industry to provide conductivity to a rubber or plastic material. Examples of such conductive agents include elemental carbon in the form of carbon black and carbon fibrils, metals such as copper, silver, gold, nickel, and alloys or mixtures of such metals. The use of such conductive agents is known in the art to dissipate static electricity in the transportation of a fluid through the tubular structure. Non-conducting elastomeric polymer materials may be employed as the inner layer in applications where dissipation of static electricity is not required.

The outer cover is a protective layer of any of the commercially recognized materials for such use such as elastomers, thermoplastic polymers, thermosetting polymers, and the like. Typically, the protective cover layer is a synthetic elastomer having good heat resistance, oil resistance, weather resistance and flame resistance. Preferably, the outer cover layer is a synthetic elastomer selected from the group consisting of styrene-butadiene rubber (SBR); butadiene-nitrile rubber such as butadiene-acrylonitrile rubber, chlorinated polyethylene, chlorosulfonated polyethylene, vinylethylene-acrylic rubber, acrylic rubber, epichlorohydrin, e.g., Hydrin 200, a copolymer of epichlorohydrin and ethylene oxide available from DuPont, polychloroprene rubber (CR), polyvinyl chloride, ethylene-propylene copolymers (EPM), ethylene-propylene-diene terpolymer (EPDM), ultra high molecular weight polyethylene (UHMWPE), high density polyethylene (HDPE), and blends thereof. Preferably, the cover layer is chlorinated polyethylene.

In accordance with the present invention, an adhesive material is typically employed between the chlorinated polyethylene inner tubular structure and the fluoropolymer barrier layer and between the fluoropolymer barrier layer and the chlorinated polyethylene backing layer or outer cover layer of the hose in order to prevent or reduce the likelihood of the layers separating during use.

Other additives such as antioxidants, fillers, plasticizers, metal oxides/hydroxides, processing aids, crosslinking agents, co-agents etc. may be employed in amounts and methods known in the art to provide their desired effects.

The tubular structures of the present invention are formed by known methods such as extruding the various layers using simultaneous, extrusion, tandum extrusion, or coextrusion. Typically, the hose of the present invention are produced by separate or tandum extrusion for versatility and economic reasons.

Having described the invention in detail and by reference to preferred embodiments thereof, it will be apparent to those skilled in the art that modifications and variations are possible without departing from the scope of the invention as defined in the appended claims.

What is claimed is:

1. A fuel filler or fuel vent hose having reduced fuel permeation, wherein said hose comprises:
a conductive inner tubular structure comprising an elastomeric nitrile or a chlorinated polyethylene;
a fluoropolymer barrier layer on said inner tubular structure; and
a chlorinated polyethylene backing layer on said fluoropolymer barrier layer,

2. The hose of claim 1, wherein said inner tubular structure is an acrylonitrile-butadiene elastomer.

3. The hose of claim 2 further comprising an adhesive layer between said fluoropolymer barrier layer and said chlorinated polyethylene backing layer.

4. The hose of claim 3 wherein said adhesive layer is a polyamine adhesive layer.

5. The hose of claim 4 wherein said polyamine adhesive layer is a polyallylamine adhesive layer.

6. The hose of claim 2, further comprising a reinforcement member between said barrier layer and said chlorinated polyethylene backing layer

7. The hose of claim 2, further comprising:
a reinforcement member on said chlorinated polyethylene backing layer wherein said reinforcement member is a material of synthetic or natural fibers selected from the group consisting of glass fibers, cotton fibers, polyamide fibers, polyester fibers, rayon fibers and blends thereof; and
a cover layer on said reinforcement member wherein said cover layer is an elastomeric polymer, thermoplastic polymer or a thermoset polymer.

8. The hose of claim 1 wherein said elastomeric inner layer is a chlorinated polyethylene.

9. The hose of claim 8 wherein said hose further comprises:
a first adhesive layer between said chlorinated polyethylene inner layer and said fluoropolymer barrier layer, and
a second adhesive layer between said fluoropolymer barrier layer and said chlorinated polyethylene backing layer.

10. The hose of claim 9 wherein each of said first adhesive layer and said second adhesive is a polyamine adhesive layer.

11. The hose of claim 10 wherein said polyamine adhesive layer is a polyallylamine adhesive layer.

12. The hose of claim 8 further comprising a reinforcement member on said fluoropolymer barrier layer.

13. The hose of claim 8 further comprising;
a reinforcement member on said chlorinated polyethylene backing layer wherein said reinforcement member is a material of synthetic or natural fibers selected from the group consisting of glass fibers, cotton fibers, polyamide fibers, polyester fibers, rayon fibers and blends thereof; and
a cover layer selected from the group consisting of elastomeric polymers, thermoplastice polymers and thermosetting polymers on said reinforcement member.

14. The tubular structure of claim 1, wherein said fluoropolymer barrier layer is selected from the group consisting of tetrafluoroethylene-hexafluoropropylene-vinylidene fluoride terpolymer (THV); a blend of about 20 to 80 weight percent of a first fluorointerpolymer having a fluorine content of about 65 to 73 weight percent with about 80 to 20 weight percent of a second fluorointerpolymer having a fluorine content of about 70 to 75 weight percent, wherein said first fluorointerpolymer is a copolymer or terpolymer formed by the copolymerization of two or more monomers selected from the group consisting of tetrafluoroethylene, hexafluoropropylene and vinylidene fluoride, and said second fluoropolymer is a terpolymer formed by the copolymerization of tetrafluoroethylene, hexafluoropropylene, and vinylidene fluoride, wherein said first fluorointerpolymer exhibits elastomeric characteristics and said second fluorointerpolymer exhibits thermoplastic characteristics; and a fluoroquad polymer derived from (i) tetrafluoroethylene (ii)hexafluoropropylene (iii) vinylidene fluoride and (iv) and a fluoroquad polymer derived from (i) tetrafluoroethylene (ii)hexafluoropropylene (iii) vinylidene fluoride and (iv) a perfluorovinyl

15. A method of manufacturing a tubular structure, said method comprising:
forming a conductive inner tubular structure having an inner surface and an outer surface, said conductive inner tubular structure comprising an acrylonitrile-butadiene elastomer or a chlorinated polyethylene elastomer;
forming a fluoropolymer barrier layer having an inner surface and an outer surface, said barrier layer comprising a fluoropolymer material on said outer surface of said conductive inner tubular structure; and
forming a chlorinated polyethylene backing layer having an inner surface and an outer surface on said fluoropolymer barrier layer;

16. The method of claim 15, wherein said inner elastomer material is a nitrile-butadiene elastomer, said method further comprising:
applying. an adhesive layer between said fluoropolymer barrier layer and said chlorinated polyethylene backing layer.

17. The method of claim 16, wherein said adhesive is a polyamine.

18. The method of claim 17, wherein said polyamine adhesive is a polyallylamine adhesive.

19. The method of claim 16 further comprising:
forming a reinforcement member between said fluoropolymer barrier layer and said chlorinated polyethylene backing layer.

20. The method of claim 16 further comprising:
forming a reinforcement member on said chlorinated polyethylene backing layer; and
forming a cover on said reinforcement member.

21. The method of claim 16, wherein said inner elastomer material is a chlorinated polyethylene, said method further comprising the step of:
applying a first polyamine adhesive layer between said conductive chlorinated polyethylene inner layer and said fluoropolymer barrier layer; and
applying a second polyamine adhesive layer between said fluoropolymer barrier layer and said chlorinated polyethylene backing layer.

22. The method of claim 16, wherein said method further comprises:
forming a reinforcement member between said fluoropolymer barrier layer and said chlorinated polyethylene backing layer.

23. The method of claim 16 wherein said method comprises:
forming a reinforcement member on said chlorinated polyethylene; and
forming a cover layer on said reinforcement member.

24. The method of claim 15, wherein said fluoropolymer barrier layer is selected from the group consisting of tetrafluoroethylene-hexafluoropropylene-vinylidene fluoride terpolymer (THV); a blend of two or more tetrafluoroethylene-hexafluoropropylene-vinylidene fluoride copolymers or terpolymers, wherein said blend is a blend of about 20 to 80 weight percent of a first fluorointerpolymer having a fluorine content of about 65 to 73 weight percent with about 80 to 20 weight percent of a second fluorointerpolymer having a fluorine content of about 70 to 75 weight percent, wherein said first fluorointerpolymer is a copolymer or terpolymer formed by the copolymerization of two or more monomers selected from the group consisting of tetrafluoroethylene, hexafluoropropylene and vinylidene fluoride, and said second fluoropolymer is a terpolymer formed by the copolymerization of tetrafluoroethylene, hexafluoropropylene, and vinylidene fluoride, wherein said first fluorointerpolymer exhibits elastomeric characteristics and said second fluorointerpolymer exhibits thermoplastic characteristics; and a fluoroquad polymer derived from (i) tetrafluoroethylene (ii)hexafluoropropylene (iii) vinylidene fluoride and (iv) and a perfluorovinyl-ether.
